(19) United States
(12) Patent Application Publication
(10) Pub. No.: US 2018/0073296 A1
(43) Pub. Date: Mar. 15, 2018

(54) CHAIN STRUCTURE FOR SCREEN DEVICE, AND CHAINING UNIT MEMBERS THEREOF

(71) Applicant: TAROKO DOOR & WINDOW TECHNOLOGIES, INC., Gaoxiong (TW)

(72) Inventor: Yihong Chen, Gaoxiong (CN)

(73) Assignee: TAROKO DOOR & WINDOW TECHNOLOGIES, INC., Gaoxiong (TW)

(21) Appl. No.: 15/560,274

(22) PCT Filed: Apr. 2, 2015
(86) PCT No.: PCT/CN2015/075806

§ 371 Date: Sep. 21, 2017

(30) Foreign Application Priority Data
Mar. 23, 2015 (CN) 201510127292.X

(51) Int. Cl. E06B 9/56; E06B 9/52

(52) U.S. Cl. CPC E06B 9/56; E06B 9/52

(57) ABSTRACT

A chain structure for a screen device comprises a plurality of chaining unit members (10). Each chaining unit member comprises a bridging portion (11), and comprises a first pivotal connection portion (12) and a second pivotal connection portion (13) that are disposed on two opposite sides of the bridging portion. The chaining unit members are connected by means of the first pivotal connection portions and the second pivotal connection portions, so as to form a chain structure (1). By means of the structure arrangement, the plurality of chaining unit members is serially connected; in this way, when the chain structure slides in the screen device, by means of the swing and pivotal movement of the bridging portions, the problems in the prior art that a member is likely to deform, the slide is not smooth and there is noise can be avoided.

### FIELD OF THE DISCLOSURE

The present disclosure relates to a chain structure, and more particularly to a chain structure for screen device, and chaining unit members thereof.

### BACKGROUND OF THE DISCLOSURE

Currently, a building structure is provided with windows, and further assembled screen devices with folding screens, or rolling screens. The sight of the building structure is not obstructed when the screen device receives the screen, and the mosquitoes and dust can be stopped from outside when the screen device unfolds the screen, so that the screen device is used more widely by people.

Furthermore, a PCT patent application No. PCT/JP2007/062506 discloses a screen device 9, as shown in FIGS. 1 and 2, wherein the screen device 9 has a screen 91, two straight frame rods 92, and two chains 93, wherein the screen 91 is disposed between the two straight frame rods 92. The two straight frame rods 92 are hollow, and the chains 93 can slip in the two straight frame rods 92. One end 931 of the chains 93 connects to the two straight frame rods 92, respectively, and the other end of the chains 932 can pass in and out from the two straight frame rods 92 through the upper and lower openings 921. When one of the straight frame rods 92 is sliding, the screen 91 can be pulled, and the chains 93 can be pulled out from the two straight frame rods 92, so that the two straight frame rods 92 can be located at the upper side and the lower side of the screen 91 for guiding the screen 91 to unfold. When the two straight frame rods 92 are sliding reversely, the screen 91 can be received, and the chains 93 are pushed into the two straight frame rods 92. In addition, the chains 93 are assembled from a plurality of chaining unit members 933, and each of the chaining unit members 933 at least has two side wall portions 934 disposed relatively, and a bridging portion 935 connected the side wall portions 934. The chaining unit members 933 are pivotally connected through the side wall portions 934 so that the chaining unit members 933 can be pivotally connected in series, and the chaining unit members 933 are pivotally swung during moving into and out from the straight frame rods 92.

However, the screen device 9 only has the benefit for receiving and unfolding the screen 91. After using the chains 93 for a long time, the side wall portions 934 of the chaining unit members 933 are easily deformed by pulling and pushing when the chaining unit members 933 pass in and out from the two straight frame rods 92, so that the pivotal movement between the chaining unit members 933 does not smoothly slide or detach. When the chains 93 are used for a while and passed in and out from the straight frame rods 92, there are problems that the chains 93 do not smoothly slide and causing noise.

Furthermore, the pivotal connection between the chaining unit members 933 of the screen device 9 is loosely matched, so that two of the chaining unit members 933 are sliding and causing noise by pivoting between the chaining unit members 933. The chains 93 within the two straight frame rods 92 hit the inner wall of the two straight frame rods 92 when the chaining unit members 933 are pivoted and shaken. Thus, the noise is louder when the chains 93 are slid.

### SUMMARY OF THE DISCLOSURE

A primary object of the present disclosure is to provide a chaining unit member for a screen device, which comprises a bridging portion, and a first pivotal connection portion and a second pivotal connection portion are formed on a front side and a back side of the bridging portion, respectively, wherein the first pivotal connection portion and the second pivotal connection portion are correspondingly pivotally connected to each other.

A chain structure for a screen device is provided, and comprises a plurality of first chaining unit members and a fastener, wherein the first chaining unit members are pivotally connected to each other to form the chain structure, and the fastener is pivotally connected to an end of one of the first chaining unit members.

The beneficial effects of the present disclosure are that: the present disclosure provides a chain structure for a screen device, and the chain structure has a plurality of chaining unit members; the chaining unit member has a bridging portion, and a first pivotal connection portion and a second pivotal connection portion are formed on a front side and a back side of the bridging portion, respectively; the chaining unit members are pivotally connected to each other by pivotally connecting the first pivotal connection portion and the second pivotal connection portion; Thus, when the chain structure slides in the screen device, the problems that a member is likely to deform, not smoothly slide and causing noise can be avoided by means of the swing and pivotal movement of the bridging portions.

A chain structure for screen device of the present disclosure is further provided, which comprises a plurality of chaining unit members, wherein a fastener is disposed between two chaining unit members adjacent to each other, and the fastener can connect two chaining unit members together. By means of this structural arrangement, the chaining unit members of the chain structure for screen device can be connected together, so that the chaining unit members can reduce to hit the inner wall of the straight frame rod during the pivotal movement. Thus the chance that a member will deform, not smoothly slide, and causing noise can be reduced when the chain structure slides in the screen device.

### DESCRIPTION OF THE DRAWINGS

FIG. 1 is a schematic view of a previous technology.

FIG. 2 is a schematic view of a chaining unit member of the previous technology.

FIG. 3 is a schematic view of a first preferred embodiment of a chaining unit member in the present disclosure.

FIG. 4 is a schematic view of a chain structure pivotally connected by the chaining unit members of the first preferred embodiment of the chaining unit member in the present disclosure.

FIG. 5 is a front view of the first preferred embodiment of the chaining unit member in the present disclosure pivotally connected to another chaining unit member.

FIG. 6 is a top view of the first preferred embodiment of the chaining unit member in the present disclosure pivotally connected to another chaining unit member.

FIG. 7 is a cross-sectional view along A-A direction shown in FIG. 6.

FIG. 8 is a schematic view of a pivotal movement of two chaining unit member.

FIG. 9 is a schematic view of the pivotal movement within the straight frame rod of the first preferred embodiment of the chaining unit member in the present disclosure.

FIG. 10 is a schematic view of a second preferred embodiment of a chaining unit member in the present disclosure.

FIG. 11 is a top view of the second preferred embodiment of the chaining unit member in the present disclosure pivotally connected to another chaining unit member.

FIG. 12 is one of schematic views of a chaining unit member of a third preferred embodiment of the chaining unit member in the present disclosure.

FIG. 13 is another schematic view of a chaining unit member of the third preferred embodiment of the chaining unit member in the present disclosure.

FIG. 14 is a schematic view of the third preferred embodiment of the chaining unit member in the present disclosure pivotally connected to another chaining unit member.

FIG. 15 is a schematic view of the chaining unit member of a fourth preferred embodiment of the chaining unit member in the present disclosure.

FIG. 16 is a top view of the fourth preferred embodiment of the chaining unit member in the present disclosure pivotally connected to another chaining unit member.

FIG. 17 is one of the schematic views of a first preferred embodiment of a chain structure in the present disclosure.

FIG. 18 is a schematic view of a first chaining unit member in the first preferred embodiment of the chain structure in the present disclosure.

FIG. 19 is a bottom view of the first chaining unit member in the first preferred embodiment of the chain structure in the present disclosure.

FIG. 20 is another schematic view of the first preferred embodiment of the chain structure in the present disclosure.

FIG. 21 is a schematic view of adding a connector in the first preferred embodiment of the chain structure in the present disclosure.

FIG. 22 is a schematic view of the connector at another perspective in the first preferred embodiment of the chain structure in the present disclosure.

FIG. 23 is a schematic view of a second preferred embodiment of the chain structure in the present disclosure.

FIG. 24 is a schematic view of a first chaining unit member in the second preferred embodiment of the chain structure in the present disclosure.

FIG. 25 is a schematic view of a fastener being a long stripe body in the second preferred embodiment of the chain structure in the present disclosure.

FIG. 26 is a schematic view of the fastener constructed by a plurality of second chaining unit members in the second preferred embodiment of the chain structure in the present disclosure.

FIG. 27 is a schematic view of the connector at another perspective in the second preferred embodiment of the chain structure in the present disclosure.

### DETAILED DESCRIPTION OF THE PREFERRED EMBODIMENTS

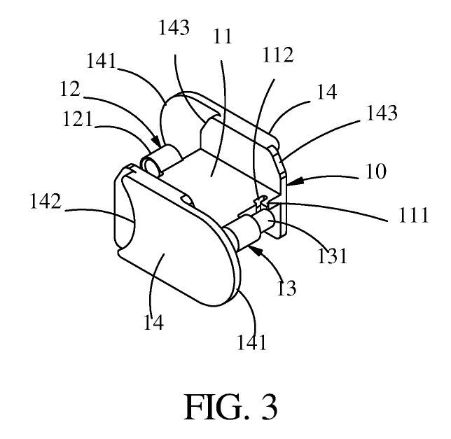

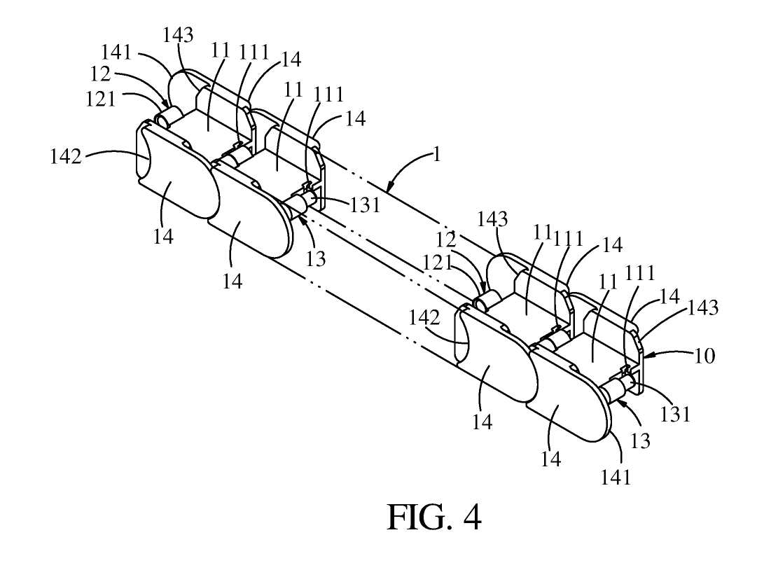

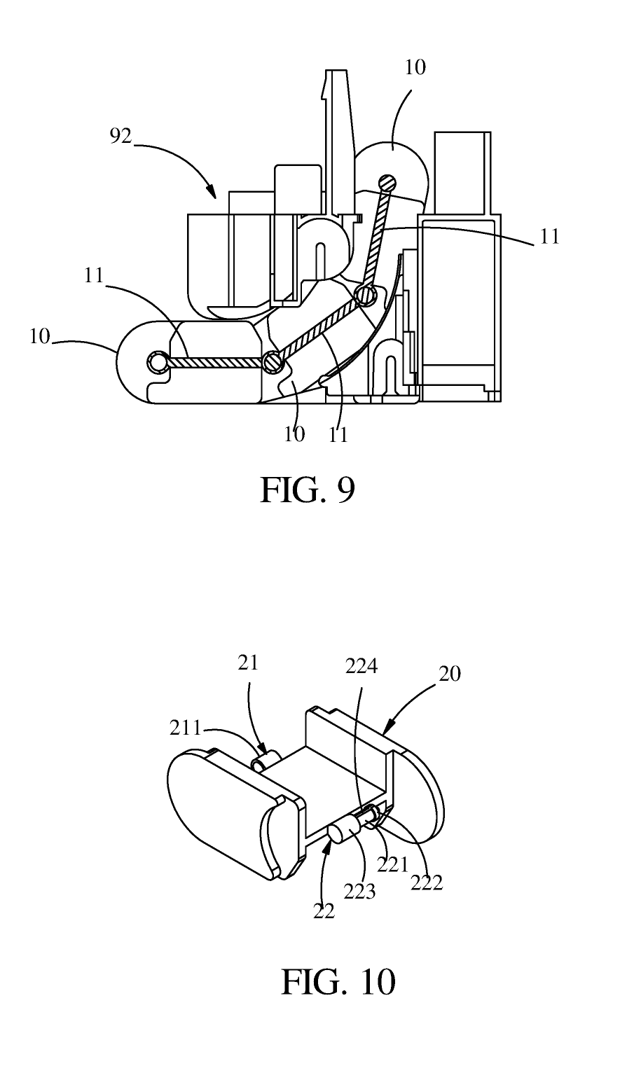

Referring to FIGS. 3, 4, and 9, a first preferred embodiment of a chaining unit member for a screen device in the present disclosure is provided. The chaining unit member 10 mainly comprises a bridging portion 11, and a first pivotal connection portion 12 and a second pivotal connection portion 13 are formed on opposite sides of the bridging portion 11. The first pivotal connection portion 12 and the second pivotal connection portion 13 are correspondingly pivotally connected to each other. A plurality of the chaining unit members 10 can be pivotally connected to each other by the first pivotal connection portion 12 and the second pivotal connection portion 13 to form a chain structure 1.

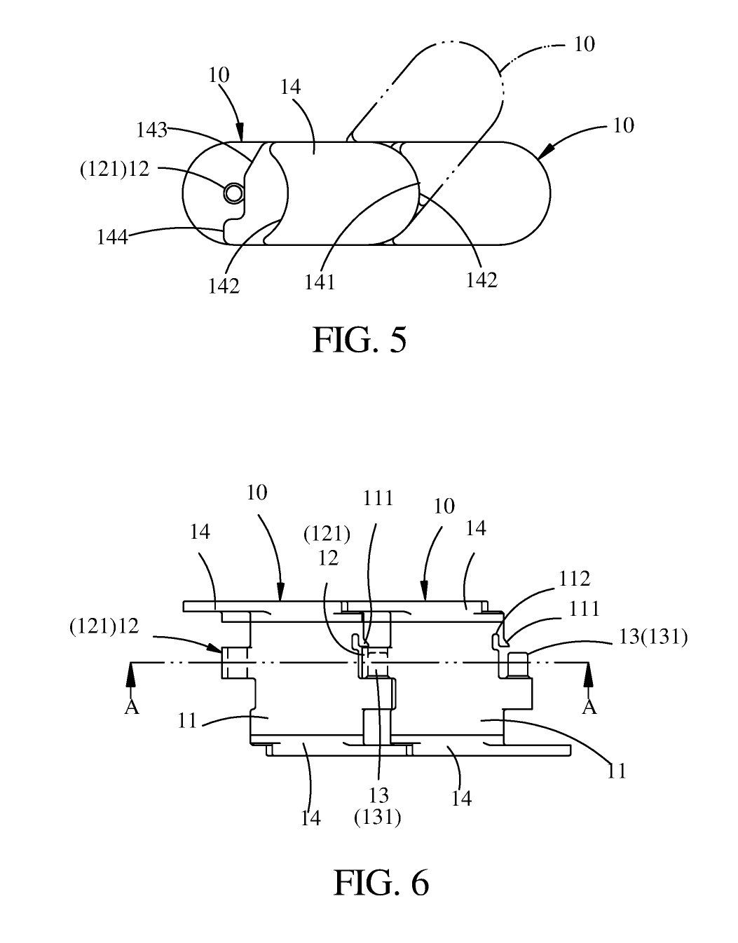

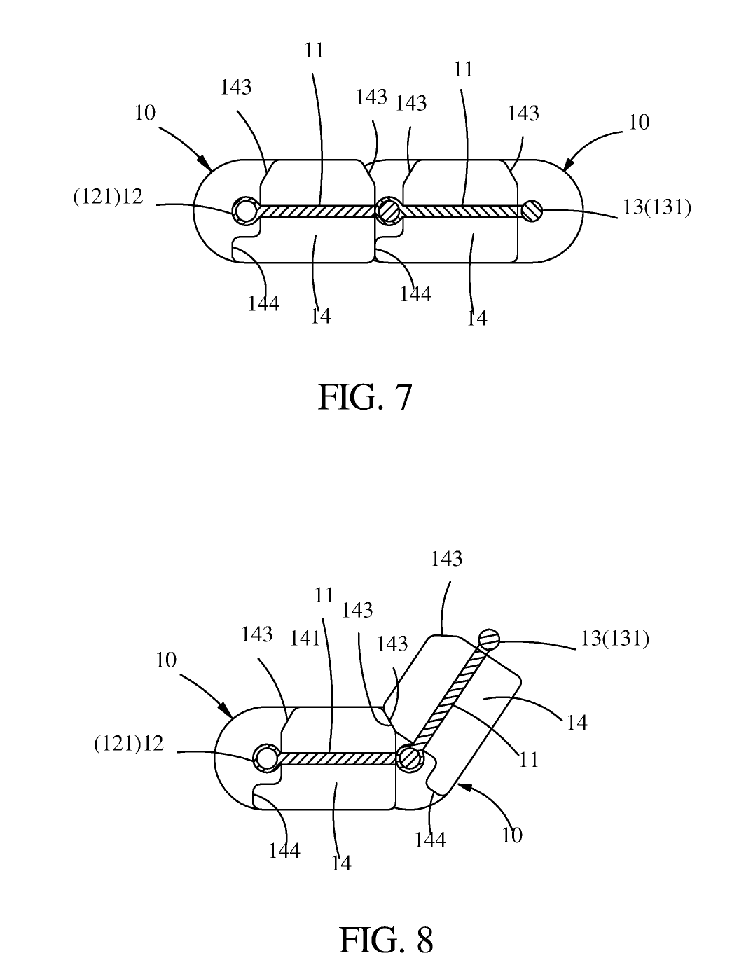

Referring to FIGS. 3 to 9, at least one side wall portion 14 is formed on opposite sides of the bridging portion 11 of the chaining unit member 10. In the embodiment, the opposite sides of the bridging portion 11 are formed with the side wall portions 14. One end of the side wall portions 14 is formed with an arc-shaped portion 141, and the other end thereof is formed with a curved recess 142. Through the design of the arc-shaped portion 141 and the curved recess 142, the arc-shaped portion 141 of chaining unit member 10 is pivoted on the curved recess 142 of another chaining unit member 10 when the chain structure 1 is pivoted (as shown by a dashed line in FIG. 5), or the curved recess 142 of the chaining unit member 10 is pivoted on the arc-shaped portion 141 of another chaining unit member 10 (not shown), so that the pivotal movement of the chaining unit members 10 is more stable and smooth. Furthermore, the side wall portions 14 of the chaining unit members 10 comprises an upper stop portion 143 and a lower stop portion 144 shown in FIGS. 7 and 8, wherein the upper stop portion 143 is formed with a slope, the upper stop portions 143 adjacent to each other can be touched to each other by the slope when the chain structure 1 is pivoted and bent (as shown in FIG. 8), so that the chaining unit member 10 can stop the pivotal movement, and prevent the chaining unit members 10 from interference or damage due to excessive bending. In the embodiment, the upper stop portion 143 can form with different slopes to adjust the pivotal angle between the chaining unit members 10. In addition, the lower stop portion 144 of the chaining unit member 10 touches the side wall portion 14 of another chaining unit member 10 when the chain structure 1 is not pivoted, so that the chaining unit members 10 can be connected in series to form a straight structure (as shown in FIG. 7).

Referring to FIGS. 3 to 9, the first pivotal connection portion 12 of the chaining unit members 10 at least has a ring portion 121 in the embodiment, and the second pivotal connection portion 13 has a protruded pivot 131. A stopper portion 111 is formed at an end of the bridging portion 11 adjacent to the protruded pivot 131 of the second pivotal connection portion 13, a compression space 112 is formed between the stopper portion 111 and the bridging portion 11, and the compression space 112 is a groove or a jack. In the embodiment, the compression space 112 is a groove, and it is not limited thereto. When assembled, a user can push the stopper portion 111 of another chaining unit members 10 by the ring portion 121 of a chaining unit member 10, and the ring portion 121 of the chaining unit member 10 is passed by the protruded pivot 131 of another chaining unit member 10 until the ring portion 121 is fully sleeved into the protruded pivot 131 of the second pivotal connection portion 13 of another chaining unit member 10, thus the assembly work of the chain structure 1 is finished with the benefits of assembly quick and convenience. The stopper portion 111 is elastically deformed toward the compression space 112 when the stopper portion 111 is pushed downward, and a rebound force is saved. Therefore, after the ring portion 121 of a chaining unit member 10 is fully sleeved into the protruded pivot 131 of the second pivotal connection portion 13 of another chaining unit member 10, the stopper portion 111 comes back to its original position by rebound force, and the stopper portion 111 can stop one end of the ring portion 121 (as shown in FIG. 6), so that the ring portion 121 detaching from the protruded pivot 131 can be avoided after assembling the chaining unit members 10. Therefore, said assembly manner can form the chain structure 1 quickly, and the structure of the assembly can be pivoted easily by the first pivotal connection portion 12 and the second pivotal connection portion 13.

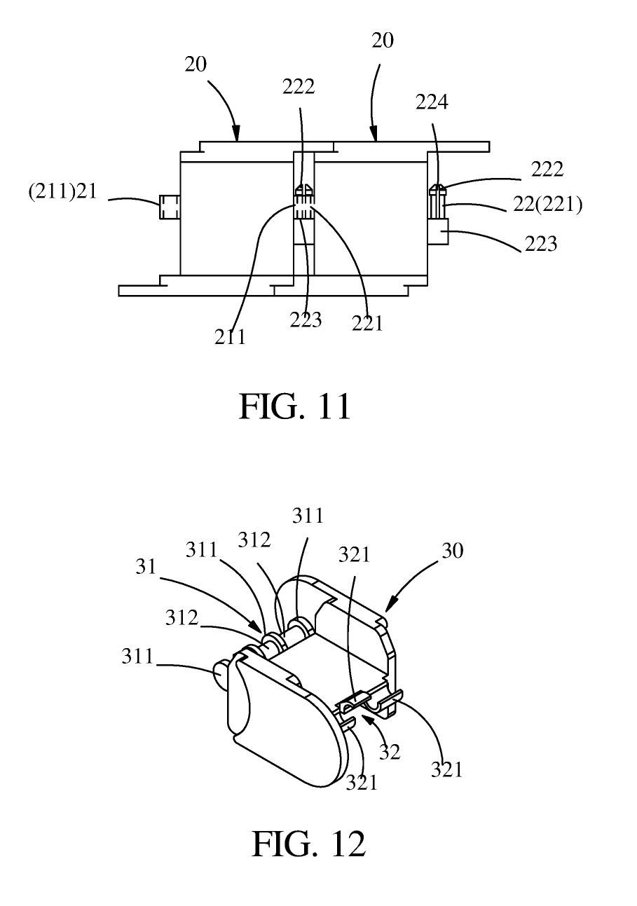

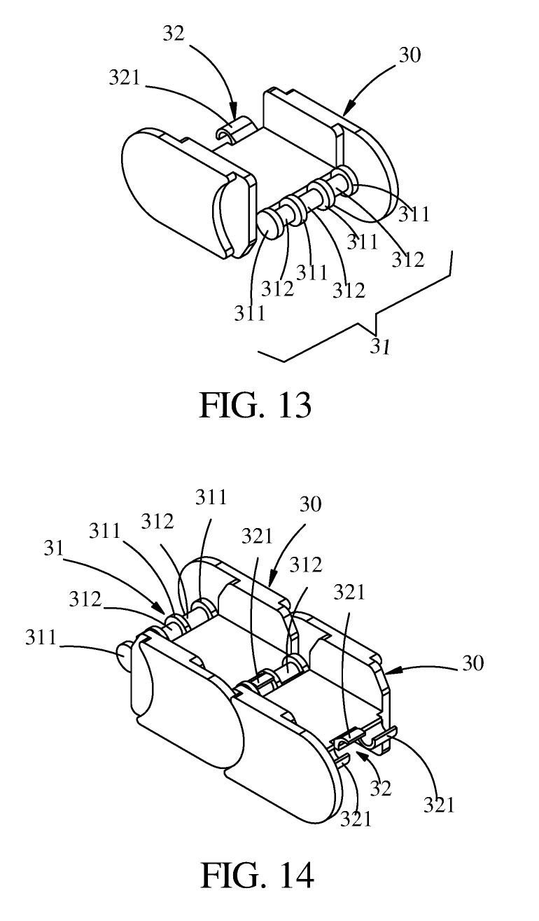

Referring to FIGS. 10 and 11, a second preferred embodiment of a chaining unit member in the present disclosure is provided. The chaining unit member 20 of the present embodiment is substantially the same as the chaining unit member 10 of the first preferred embodiment, the difference lies in the point, a first pivotal connection portion 22 of the chaining unit member 20 has a ring portion 211, and a second pivotal connection portion 22 at least has a protruded pivot 221. A front stop portion 222 and a rear stop portion 223 are formed on two ends of the protruded pivot 221 corresponding to the ring portion 211, respectively, and a gap 224 is formed between the protruded pivot 221 and the front stop portion 222. The front stop portion 222 and the protruded pivot 221 have an amount of elastic compression by disposing the gap 224. When the protruded pivot 221 of the chaining unit member 20 is assembled into the ring portion 211 of another chaining unit member 20, the front stop portion 222 is elastically deformed at touching the inner edge of the ring portion 211. Thus, the outer diameter of the front stop portion 222 and the protruded pivot 221 are reduced, and the front stop portion 222 and the protruded pivot 221 smoothly pass through the ring portion 211. After the front stop portion 222 passes through the ring portion 211 (as shown in FIG. 10), the front stop portion 222 comes back to its original position by elasticity without the limitation of the inner diameter of the ring portion 211. The outer diameter of the front stop portion 222 and the rear stop portion 223 are greater than the inner diameter of the ring portion 211, so that the protruded pivot 221 cannot detach from the ring portion 121 by disposing the front stop portion 222 and the rear stop portion 223 (as shown in FIG. 11), and the protruded pivot 221 can easily pivot in the ring portion 211.

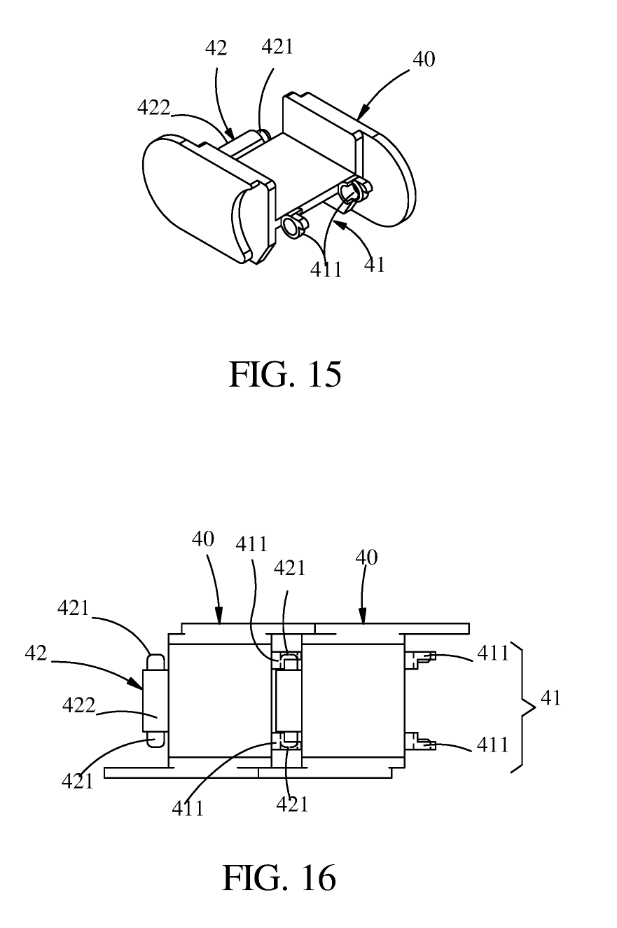

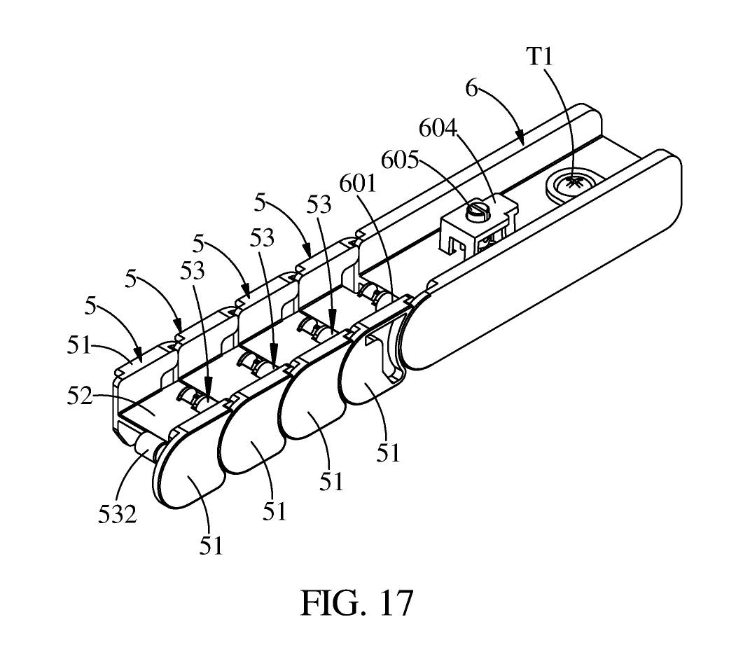

Referring to FIGS. 12 to 14, a third preferred embodiment of a chaining unit member in the present disclosure is provided. The chaining unit member 30 of the present embodiment is substantially the same as the chaining unit members 10, 20 of the first and second preferred embodiments, the difference lies in the point, a first pivotal connection portion 31 of the chaining unit member 30 has two protruded portions 311 and a pivoting shaft 312 connected between the protruded portions 311, and a second pivotal connection portion 32 is formed with a bending portion 321 corresponding to the pivoting shaft 312 of the first pivotal connection portion 31. In the embodiment, the first pivotal connection portion 31 is formed with four protruded portions 311, and three pivoting shafts 312 are disposed among the protruded portions 311. The second pivotal connection portion 32 forms three bending portions 321 corresponding to the pivoting shafts 312. The bending portions 321 are staggered in different directions. When assembled, the bending portion 321 of the second pivotal connection portion 32 has an ability of elastic deformation. When the bending portions 321 touch the pivoting shaft 312 of the first pivotal connection portion 31, the bending portions 321 have an elastic deformation. Only after the bending portions 321 cross the pivoting shafts 312 of the first pivotal connection portion 31, the bending portions 321 come back to their original position. The bending portions 321 hang on the upper edge and the lower edge of the pivoting shaft 312, respectively (as shown in FIG. 14). The bending portions 321 of the chaining unit member 30 can hang on the pivoting shaft 312 of another chaining unit member 30 for assembling, and the chaining unit members 30 are easily pivoted.

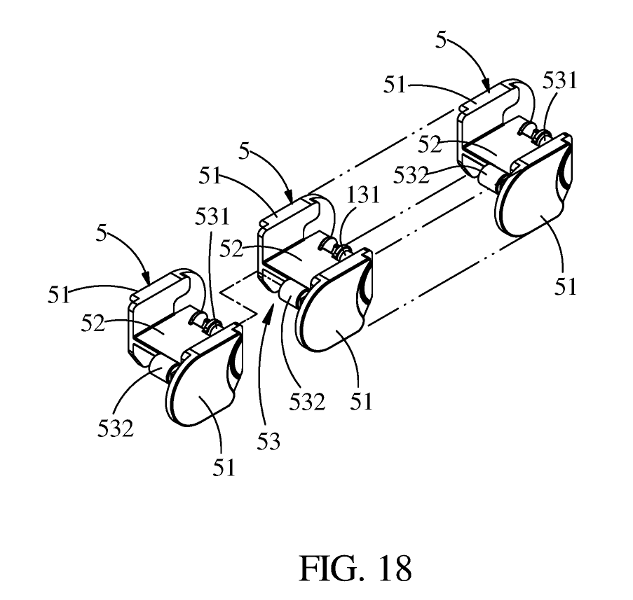

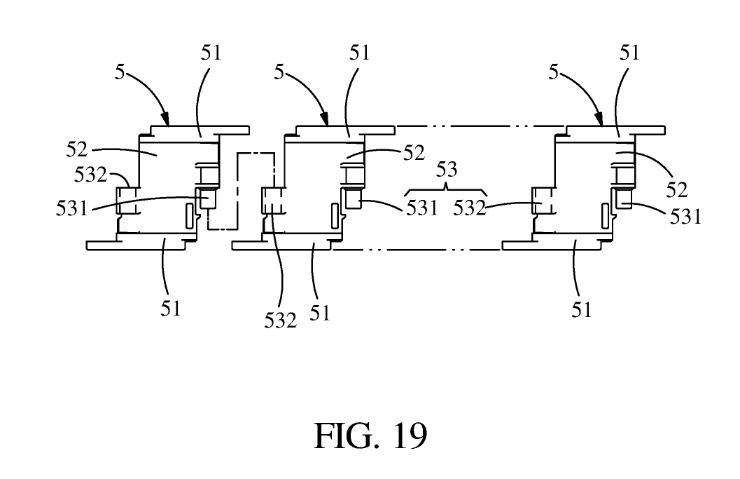

Referring to FIGS. 15 and 16, a fourth preferred embodiment of a chaining unit member in the present disclosure is provided. The chaining unit member 40 of the present embodiment is substantially the same as the chaining unit members 10, 20, 30 of the first, second, and third preferred embodiments, the difference lies in the point, a first pivotal connection portion 41 between two of the chaining unit members 40 has at least two collars 411. In the embodiment, one of the collars 411 is elastic, and the other collar 411 is not elastic. A second pivotal connection portion 42 has a pivoting shaft 421 pivotally connected between the two collars 411 of the first pivotal connection portion 41, and a middle section of the pivoting shaft 421 is formed with a different section portion 422 with a larger diameter. Since one of the collars 411 is elastic, an end of the pivoting shaft 421 is passed through the collar 411 of the chaining unit member 40 without elasticity, and the other collar 411 with elasticity is pulled to deform for increasing a distance between the collars 411. The other end of the pivoting shaft 421 passed through the collar 411 with elasticity, and the collar 411 of another chaining unit member 40 comes back to original position by elasticity. Thus, the pivoting shaft 421 of the chaining unit member 40 is set between two collars 411 of another chaining unit member 40, and pivoted easily. Furthermore, a length of the different section portion 422 of the chaining unit members 40 equals the distance between two collars 411, thus the pivoting shaft 421 detached from the collar 411 can be avoid when pivoting shaft 421 is pivoted in the collar 411.

As described in the above-mentioned embodiments, the chaining unit members are connected in series by pivoting the first pivotal connection portion and the second pivotal connection portion on the bridging portion, and the bridging portion can be pivoted by disposing the first pivotal connection portion and the second pivotal connection portion when the chain structure slides in the screen device, the problems that a member is likely to deform, not smoothly slide, and causing noise can be avoided by means of the swing and pivotal movement of the bridging portions.

Referring to FIGS. 17 and 22, a first preferred embodiment of a chain structure in the present disclosure is provided, which comprises a plurality of first chaining unit members 5 and a fastener 6, wherein the first chaining unit members 5 are pivotally connected to each other (as shown in FIGS. 18 and 19). Each of the first chaining unit members 5 at least has a side wall portion 51 and a bridging portion 52. In the embodiment, the first chaining unit members 5 is formed with two side wall portions 51, and the side wall portions 51 are formed on two opposite side of the bridging portion 52. Two of the bridging portions 52 of the first chaining unit members 5 adjacent to each other are provided with a pivoting device 53. The pivoting device 53 can pivotally connect two bridging portions 52 of the first chaining unit members 5 adjacent to each other. The pivoting device 53 has a first pivotal connection portion 531 and a second pivotal connection portion 532, and the first pivotal connection portion 531 and the second pivotal connection portion 532 are partially formed on two of the bridging portions 52 adjacent to each other for connecting the first pivotal connection portion 531 with the second pivotal connection portion 532, so that the chaining unit members 5 are pivotally connected to each other. In the embodiment, the first pivotal connection portion 531 and the second pivotal connection portion 532 are a shaft body and a ring portion, respectively. It is not limited thereto.

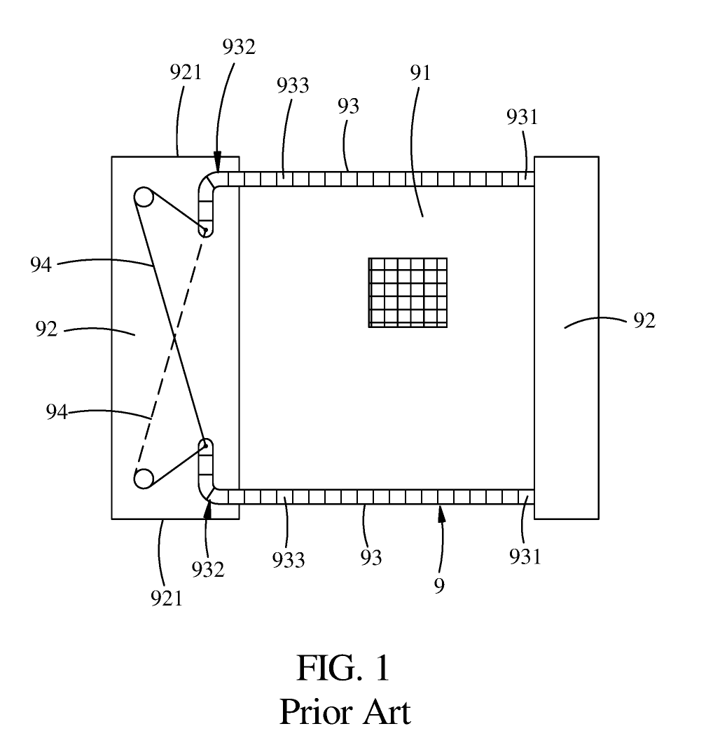

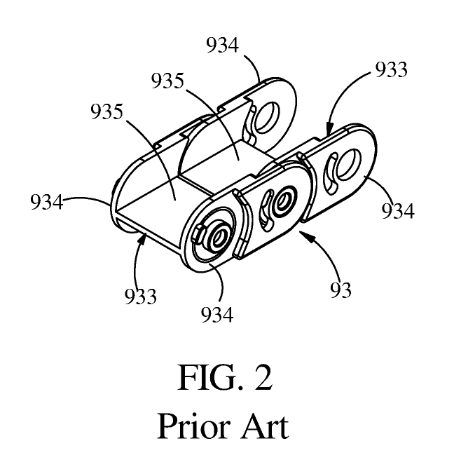

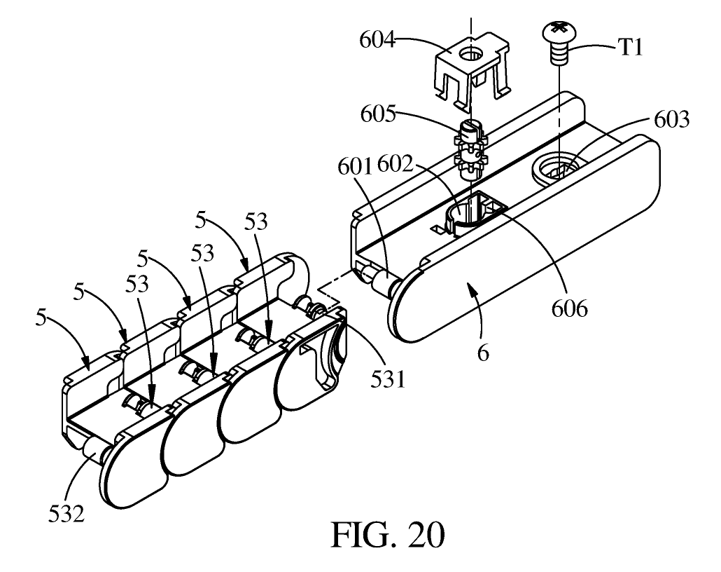

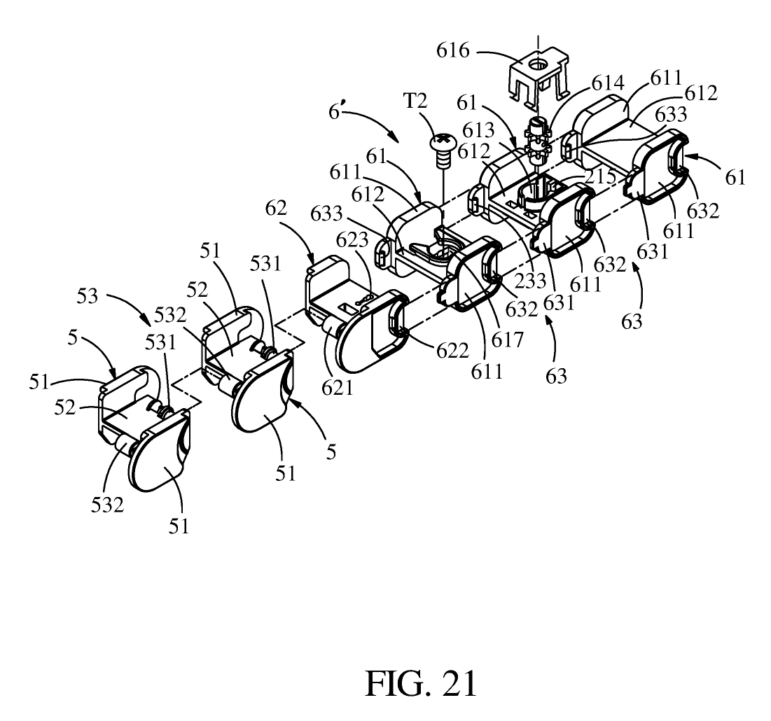

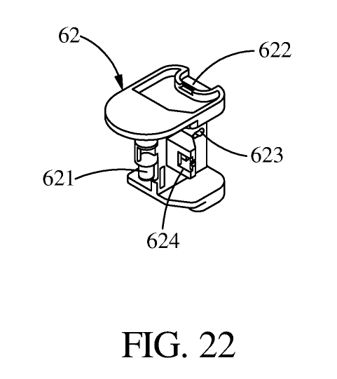

Referring to FIGS. 1, 17, and 20 to 22, one end of the fastener 6 is pivotally connected to one end of the chain structure formed from the first chaining unit members 5. In the embodiment, the fastener 6 is a long stripe body, or the second chaining unit members 61 connected to each other. When the fastener 6 is a long stripe body (as shown in FIGS. 17 and 20), the fastener 6 is formed with a ring portion 601 or a shaft body (not shown) corresponding to the first pivotal connection portion 531 or the second pivotal connection portion 532 of the pivoting device 53 of the first chaining unit members 5 for pivotally connecting with the first chaining unit members 5. When the fastener 6 slides in the straight frame rod 92 of the screen device 9, the fastener 6 can reduce to hit the inner wall of the straight frame rod 92 during the pivotal movement. Thus, a member which is not smoothly slid and causing noise can be reduced in the embodiment.

Referring to FIGS. 1, 17, and 20, the fastener 6 is formed with a recess 602, a screw hole 603, and a fixed base 604, wherein the recess 602 is provided with a gear 605, a limiting rib 606 is formed on a hole wall of the recess 602 and corresponding to a space between teeth of the gear 605. The screw hole 603 is screwed with a screw assembly T1, and one end of a pulling rope 94 of the screen device 9 can be wound on the gear 605, and tie on the screw assembly T1. Thus, the screw assembly T1 is tightly screwed in the screw hole 603 to fix the pulling rope 94 with the fastener 6. The gear 605 is turned for adjusting the tension of the pulling rope 94. When the tension of the pulling rope 94 is adjusted to a suitable status, the limiting rib 606 can engage in the space between teeth of the gear 605, so that the gear 605 is stopped and does not turn. The expected benefit for adjusting the tension of the pulling rope 94 can be achieved. In addition, one end of the fixed base 604 is disposed on an end of the gear 605, and the other end of the fixed base 604 is disposed on the fastener 6. Thus, the gear 605 is assembled in the recess 602, and cannot be detached form the recess 602.

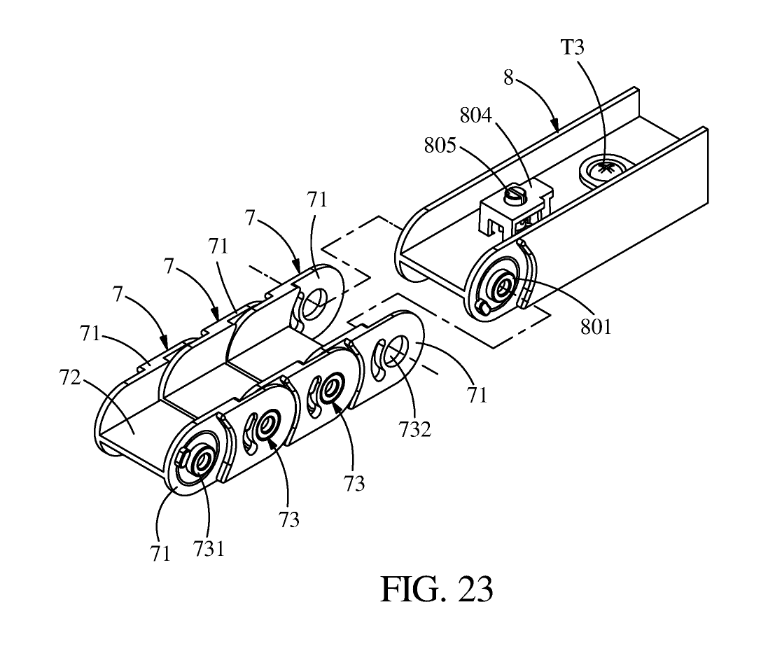

Referring to FIGS. 1 and 21, the fastener 6′ has a plurality of second chaining unit members 61 and a connector 62, wherein the second chaining unit members 61 are pivotally connected to each other. Each of the second chaining unit members 61 at least has a side wall portion 611 and a bridging portion 612. In the embodiment, each of the second chaining unit members 61 is provided with two side wall portion 611, and the side wall portions 611 are formed on two opposite sides of the bridging portion 612. Two of the side wall portions 611 of the second chaining unit members 61 adjacent to each other are formed with a fixing device 63 for connecting two of the adjacent side wall portions 611 of the second chaining unit members 61 to each other. The fixing device 63 at least has a first fixing portion 631 and a second fixing portion 632 for connecting to the first fixing portion 631, and the first fixing portion 631 and the second fixing portion 632 are partially formed on two of the side wall portions 611 of the second chaining unit members 61 adjacent to each other. In the embodiment, the first fixing portion 631 and the second fixing portion 632 are an insert and a slot, respectively. It is not limited thereto. One end of the insert of the first fixing portion 631 is provided with a hooking portion 633, and the slot of the second fixing portion 632 is provided with a hooking slot corresponding to the hooking portion 633 of the first fixing portion 631 (not shown). When the first fixing portion 631 and the second fixing portion 632 are fixed, the hooking portion 633 connects to the hooking slot. Thus, the second chaining unit members 61 cannot be detached at sliding. Furthermore, when the fastener 6′ slides in the straight frame rod 92 of the screen device 9, the fastener 6′ can reduce to hit the inner wall of the straight frame rod 92 during the pivotal movement. Thus a member is not smoothly slide and causing noise can be reduced in the embodiment.

Referring to FIGS. 1 and 21, the bridging portion 612 of one of the second chaining unit members 61 of the fastener 6′ is formed with a recess 613, wherein a limiting rib 615 is formed on a hole wall of the recess 613 and corresponding to the space between teeth of the gear 614. The pulling rope 94 of the screen device 9 winds on the gear 605, so that the tension of the pulling rope 94 can be adjusted by turning the gear 614. When the tension of the pulling rope 94 is adjusted to a suitable status, the limiting rib 615 can engage the space between teeth of the gear 614, so that the gear 614 is stopped and does not turn. The expected benefit for adjusting the tension of the pulling rope 94 can be achieved. In addition, the fixed base 616 is formed between the bridging portion 612 and an end of the gear 614 protruded out of the recess 613 for limiting the gear 614. The gear 614 cannot be detached form the recess 613.

Referring to FIGS. 1 and 21, the bridging portion 612 of one of the second chaining unit member 61 of the fastener 6′ is formed with a screw hole 617, and a screw assembly T2 is screwed in the screw hole 617. When the tension of the pulling rope 94 is adjusted to a suitable status, the pulling rope 94 can tie or wind on the screw assembly T2. The pulling rope 94 of the screen device 9 can be fixed after screwing the screw assembly T2 in the screw hole 617.

Referring to FIGS. 1, 21, and 22, the connector 62 is disposed between the first chaining unit members 5 and the second chaining unit members 61. The connector 62 is formed with a first connecting portion 621 and a second connecting portion 622 corresponding to the pivoting device 53 of the first chaining unit member 5 and the fixing device 63 of the second chaining unit member 61, respectively. The first connecting portion 621 is pivotally connected to the pivoting device 53 of the first chaining unit member 5, and the second connecting portion 622 are pivotally connected to the fixing device 63 of the second chaining unit member 61. In the embodiment, the first connecting portion 621 is one of the shaft body and the ring portion, and the second connecting portion 622 is one of the insert and the slot. In addition, the connector 62 further comprises a threading hole 623 and a stop protrusion 624. Referring to FIG. 22, the threading hole 623 is provided for passing the pulling rope 94 of the screen device 9, and the stop protrusion 624 is provided for engaging the upper and lower openings 921 of the two straight frame rods 92 of the screen device 9. Thus, the second chaining unit members 61 can prevent to slip out from the upper and lower openings 921 of the two straight frame rods 92 of the screen device 9.

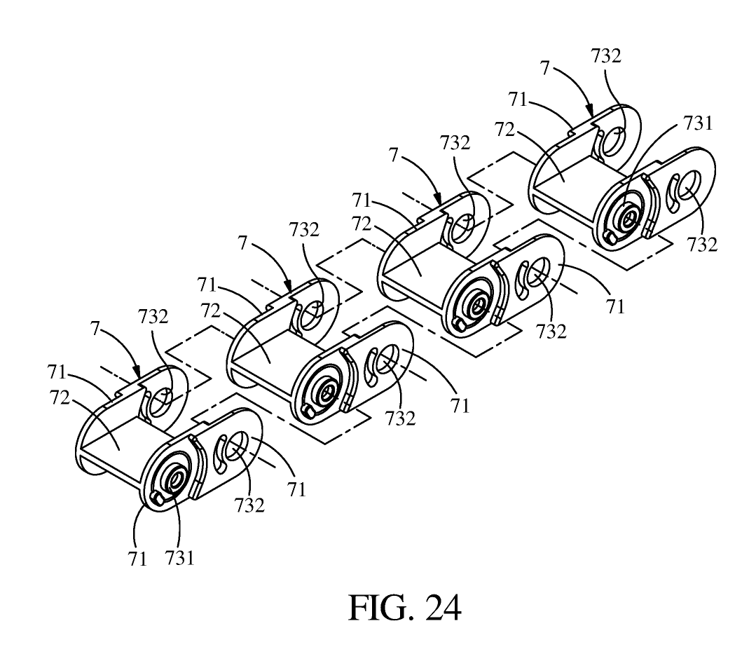

Referring to FIGS. 23 to 22, a second preferred embodiment of the chain structure in the present disclosure is provided, which has a plurality of first chaining unit members 7 and a fastener 8, wherein the first chaining unit members 7 are pivotally connected to each other in FIGS. 23 and 24. Each of the first chaining unit members 7 at least has a side wall portion 71 and a bridging portion 72. In the embodiment, the first chaining unit member 7 is formed with two side wall portions 71, and the side wall portions 71 are formed on two opposite sides of the bridging portion 72. Two of the bridging portions 71 of the first chaining unit members 7 adjacent to each other are provided with a pivoting device 73. The pivoting device 73 pivotally connects two side wall portions 71 of the first chaining unit members 7 together. The pivoting device 73 has a first pivotal connection portion 731 and a second pivotal connection portion 732, the first pivotal connection portion 731 and the second pivotal connection portion 732 are partially formed on side wall portions 71 adjacent to each other for connecting the first pivotal connection portion 731 with the second pivotal connection portion 732, so that the chaining unit members 7 are pivotally connected to each other. In the embodiment, the first pivotal connection portion 731 and the second pivotal connection portion 732 are a shaft body and a ring portion, respectively.

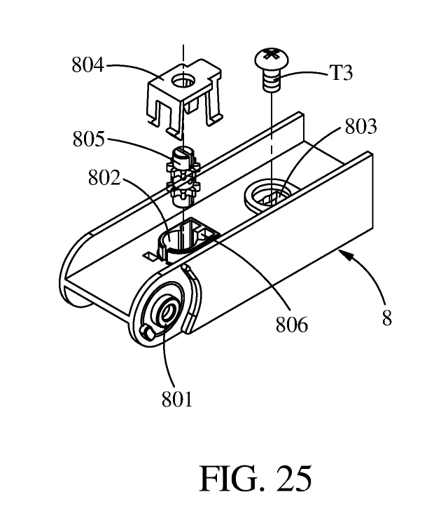

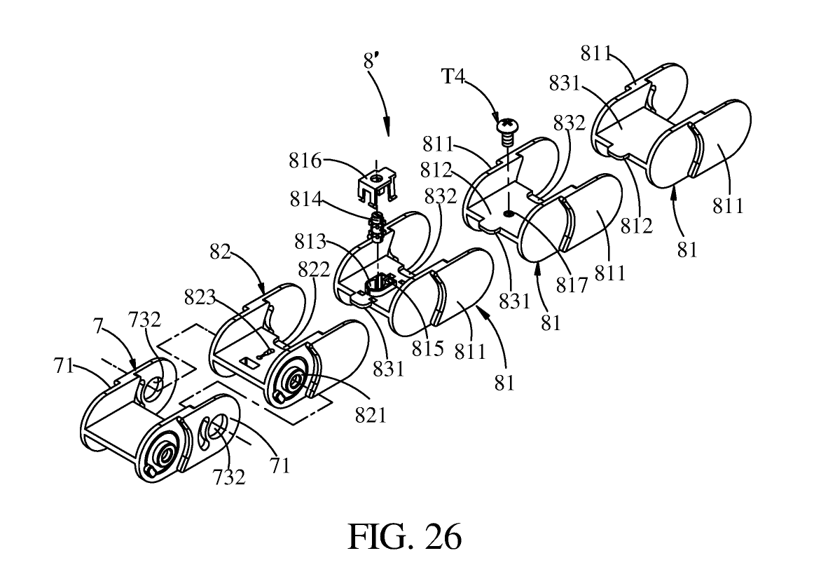

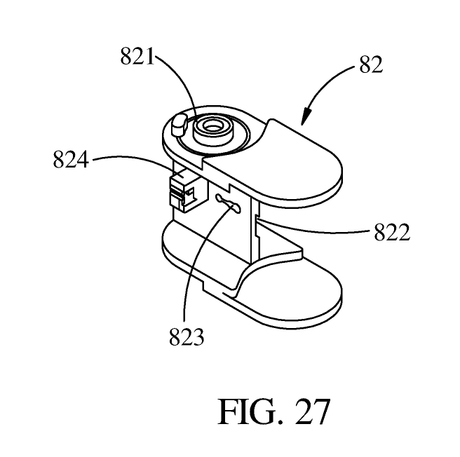

Referring to FIGS. 23 and 26, one of the fasteners 8 and one of the chain structures formed by the first chaining unit members 7 are pivotally connected. In the embodiment, the fastener 8 is a long stripe body, or a plurality of second chaining unit members 81 connected together. When the fastener 8 is a long stripe body (as shown in FIG. 25), the fastener 8 is formed with a ring portion (not shown) or a shaft body 801 corresponding to the first pivotal connection portion 731 or the second pivotal connection portion 732 of the pivoting device 73 of the first chaining unit members 7 for pivotally connecting with the first pivotal connection portion 731 or the second pivotal connection portion 732 of the pivoting device 73. Therefore, when the fastener 8 slides in the two straight frame rod 92 of the screen device 9, the fastener 8 can reduce to hit the inner wall of the straight frame rod 92 during the pivotal movement by designing the long stripe body. Thus a member is not smoothly slide and causing noise can be reduced in the embodiment.

Referring to FIG. 25, the fastener 8 is formed with a recess 802, a screw hole 803, and a fixed base 804, wherein the recess 802 is provided with a gear 805, a limiting rib 806 is formed on a hole wall of the recess 802 and corresponding to a space between teeth of the gear 805. The screw hole 803 is screwed with a screw assembly T3, and the pulling rope 94 of the screen device 9 wind on the gear 805, and tie on the screw assembly T3 so that screw assembly T3 is screwed, and the pulling rope 94 is fixed on the screw hole 803 of the fastener 8. The gear 805 is turned for adjusting the tension of the pulling rope 94. When the tension of the pulling rope 94 is adjusted to a suitable status, the limiting rib 806 can engage in the space between teeth of the gear 805, so that the gear 805 is stopped and does not turn. The expected benefit for adjusting the tension of the pulling rope 94 can be achieved. In addition, one end of the fixed base 804 is disposed on an end of the gear 805, and the other end of the fixed base 804 is disposed on the fastener 8. Thus, the gear 805 is assembled in the recess 802, and cannot be detached form the recess 802.

Referring to FIGS. 1 and 26, the fastener 8′ has a plurality of second chaining unit members 81 and a connector 82, wherein the second chaining unit members 81 are pivotally connected to each other. Each of the second chaining unit members 81 at least has a side wall portion 811 and a bridging portion 812. In the embodiment, each of the second chaining unit members 81 is provided with two side wall portion 811, and the side wall portions 811 are formed on two opposite sides of the bridging portion 812. Two of the side wall portions 811 of the second chaining unit members 81 adjacent to each other are formed with a fixing device 83 for connecting two of the adjacent side wall portions 811 of the second chaining unit members 81 to each other. The fixing device 83 at least has a first fixing portion 831 and a second fixing portion 832 for connecting to the first fixing portion 831, and the first fixing portion 831 and the second fixing portion 832 are partially formed on two of the side wall portions 811 of the second chaining unit members 81 adjacent to each other. In the embodiment, the first fixing portion 831 and the second fixing portion 832 are an insert and a slot, respectively. It is not limited thereto. One end of the insert of the first fixing portion 831 is provided with a hooking portion (not shown) as the first preferred embodiment, and the slot of the second fixing portion 832 is provided with a hooking slot corresponding to the hooking portion (not shown). When the first fixing portion 831 and the second fixing portion 832 are fixed, the hooking portion connects to the hooking slot. Thus, the second chaining unit members 81 cannot be detached at sliding. Furthermore, when the fastener 8′ slides in the straight frame rod 92 of the screen device 9, the second chaining unit members 81 of the fastener 8′ are fixed together, and the fastener 8′ can reduce to hit the inner wall of the straight frame rod 92 during the pivotal movement. Thus members which cannot smoothly slide and causing noise can be reduced in the embodiment. When the first fixing portion 831 is an insertion plate, the first fixing portion 831 can be made of soft material. When the fastener 8′ is sliding, the first fixing portion 831 made of soft material can absorb a portion of the vibration, and thus members which cannot smoothly slide and causing noise can be reduced to the minimum.

Referring to FIGS. 1 and 26, the bridging portion 812 of one of the second chaining unit members 81 of the fastener 8′ is formed with a recess 813, wherein a limiting rib 815 is formed on a hole wall of the recess 813 and corresponding to the space between teeth of the gear 814. The pulling rope 94 of the screen device 9 winds on the gear 605, so that the tension of the pulling rope 94 can be adjusted by turning the gear 814. When the tension of the pulling rope 94 is adjusted to a suitable status, the limiting rib 815 can engage the space between teeth of the gear 814, so that the gear 814 is stopped and does not turn. The expected benefit for adjusting the tension of the pulling rope 94 can be achieved. In addition, the fixed base 816 is formed between the bridging portion 812 and an end of the gear 814 protruded out of the recess 813 for limiting the gear 814. The gear 814 cannot be detached form the recess 813.

Referring to FIGS. 1 and 26, the bridging portion 812 of one of the second chaining unit member 81 of the fastener 8′ is formed with a screw hole 817, and a screw assembly T4 is screwed in the screw hole 817. When the tension of the pulling rope 94 is adjusted to a suitable status, the pulling rope 94 can tie or wind on the screw assembly T4. The pulling rope 94 of the screen device 9 can be fixed after screwing the screw assembly T4 in the screw hole 817.

Referring to FIGS. 1 and 26, the connector 82 is disposed between the first chaining unit members 7 and the second chaining unit members 81. The connector 82 is formed with a first connecting portion 821 and a second connecting portion 822 corresponding to the pivoting device 73 of the first chaining unit member 7 and the fixing device 83 of the second chaining unit member 81, respectively. The first connecting portion 821 are pivotally connected to the pivoting device 73 of the first chaining unit member 7, and the second connecting portion 822 are pivotally connected to the fixing device 83 of the second chaining unit member 81. In the embodiment, the first connecting portion 821 is one of the shaft body and the ring portion, and the second connecting portion 822 is one of the inserts and the slots. In the embodiment, the first connecting portion 821 is a shaft body, and the second connecting portion 822 is a slot, and the slot is formed with a hooking slot (not shown). In addition, the connector 82 further comprises a threading hole 823 and a stop protrusion 824. Referring to FIG. 27, the threading hole 823 is provided through which the pulling rope 94 of the screen device 9 can pass, and the stop protrusion 824 is provided for engaging against the upper and lower openings 921 of the straight frame rod 92 of the screen device 9. Thus, the second chaining unit members 81 can prevent from sliding out from the upper and lower openings 921 of the two straight frame rods 92 of the screen device 9.

However, those described above are only the preferred embodiments of the present disclosure, which thus cannot be used to limit the scope of the present disclosure. Generally, any equivalent changes and modifications based on claims of the present disclosure will not lose the essence of the present disclosure, and not depart from the spirit and scope of the present disclosure, and thus should be regarded as further implementations of the present disclosure.

1. A chaining unit member for a screen device, comprising:
a bridging portion, wherein two further opposite sides of the bridging portion of the chaining unit member are formed with at least one side wall portion;
a first pivotal connection portion and a second pivotal connection portion formed on a front side and a back side of the bridging portion, respectively;
wherein the first pivotal connection portion and the second pivotal connection portion are correspondingly pivotally connected to each other.

2. The chaining unit member according to claim 1, wherein the first pivotal connection portion has at least one ring portion, and the second pivotal connection portion has a protruded pivot is pivotally connected to the ring portion of the first pivotal connection portion.

3.-4. (canceled)

5. The chaining unit member according to claim 1, wherein the first pivotal connection portion has at least two protruded portions and a pivoting shaft connected between the protruded portions, and the second pivotal connection portion has a hanging portion for hanging to the pivoting shaft of the first pivotal connection portion.

6. The chaining unit member according to claim 1, wherein the first pivotal connection portion between two of the chaining unit members has at least two collars, and the second pivotal connection portion has a pivoting shaft pivotally connected between the two collars of the first pivotal connection portion.

7. (canceled)

8. The chaining unit member according to claim 1, wherein one end of the side wall portion is arc-shaped, and the other end thereof is formed with a curved recess.

9. The chaining unit member according to claim 1, wherein the side wall portion is formed with an upper stop portion.

10. The chaining unit member according to claim 1, wherein the side wall portion is formed with a lower stop portion.

11. A chain structure for a screen device, comprising:
a plurality of first chaining unit members; and
a fastener, the fastener is constructed by a plurality of second chaining unit members connected with each other;
wherein the first chaining unit members are pivotally connected to each other to form the chain structure, and the fastener is pivotally connected to an end of one of the first chaining unit members.

12.-19. (canceled)

20. The chain structure for the screen device according to claim 8, wherein each of the second chaining unit member at least has a side wall portion and a bridging portion, wherein the side wall portion is formed on a side of the bridging portion, and two of the side wall portions of the second chaining unit members adjacent to each other are formed with a fixing device for connecting two of the adjacent second chaining unit members to each other.

21. The chain structure for the screen device according to claim 9, wherein the fixing device at least has a first fixing portion and a second fixing portion for connecting to the first fixing portion, and the first fixing portion and the second fixing portion are partially formed on two of the side wall portions of the second chaining unit members adjacent to each other.

22. The chain structure for the screen device according to claim 9, wherein the bridging portion of one of the second chaining unit members of the fastener is formed with a recess and a fixed base, wherein the recess is provided with a gear, a limiting rib is formed on a hole wall of the recess and corresponding to a space between teeth of the gear, and the fixed base is disposed between the bridging portion and an end of the gear protruded out of the recess.

23. The chain structure for the screen device according to claim 9, wherein the bridging portion of one of the second chaining unit members of the fastener is formed with a screw hole, and a screw assembly is screwed in the screw hole.

24. The chain structure for the screen device according to claim 8, wherein the fastener further comprises a connector disposed between the first chaining unit member and the second chaining unit member, wherein the connector is formed with a first connecting portion and a second connecting portion corresponding to the pivoting device of the first chaining unit member and the fixing device of the second chaining unit member, respectively; the first connecting portion are pivotally connected to the pivoting device of the first chaining unit member, and the second connecting portion is connected to the fixing device of the second chaining unit member.

25. The chain structure for the screen device according to claim 8, wherein each second chaining unit member at least has a side wall portion and a bridging portion, wherein the side wall portion is formed on a side of the bridging portion, and two of the bridging portions of the second chaining unit members adjacent to each other are formed with a fixing device for connecting two of the adjacent second chaining unit members to each other.

26. The chain structure for the screen device according to claim 14, wherein the fixing device has a first fixing portion and a second fixing portion for connecting to the first fixing portion, and the first fixing portion and the second fixing portion are partially formed on two of the bridging portions of the second chaining unit members adjacent to each other.

27. The chain structure for the screen device according to claim 8, wherein the bridging portion of one of the second chaining unit member of the fastener is formed with a recess and a fixed base, wherein the recess is provided with a gear, a limiting rib is formed on a hole wall of the recess and corresponding to a space between teeth of the gear, and the fixed base is formed between the bridging portion and an end of the gear protruded out of the recess.

28. The chain structure for the screen device according to claim 8, wherein the bridging portion of one of the second chaining unit member of the fastener is formed with a screw hole, and a screw assembly is screwed in the screw hole.
